(19) United States
(12) Patent Application Publication
(10) Pub. No.: US 2025/0144931 A1
(43) Pub. Date: May 8, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: FUMITAKA GOTO, Tokyo (JP); TOMOKAZU ISHIKAWA, Kanagawa (JP); YUTA IKESHIMA, Kanagawa (JP); TAKAHISA AKAISHI, Kanagawa (JP)

(21) Appl. No.: 18/933,489

(22) Filed: Oct. 31, 2024

(30) Foreign Application Priority Data
Nov. 6, 2023 (JP) 2023-189478

(51) Int. Cl. B41J 2/04; B41J 2/21; G06K 15/02

(52) U.S. Cl. CPC B41J 2/04; B41J 2/21; G06K 15/1822; G06K 2215/101

(57) ABSTRACT

When a foaming promotion component is applied to a recording medium including a foaming layer containing foamable particles to foam, a forming height of an edge of a forming region may decrease. An image processing apparatus detects an edge pixel located inside the forming region at a border of the foaming region with a non-foaming region and increases an amount of application of the foaming promotion component, thereby being able to prevent a decrease in the forming height.

### BACKGROUND

### Field

The present disclosure relates to an image processing apparatus, an image processing method, and a storage medium for recording an image on a recording medium.

### Description of the Related Art

A recording medium including a foaming layer that foams thermally has been known, and a three-dimensional image forming system that forms a three-dimensional image by foaming desired regions has been known.

To foam the desired regions, the three-dimensional image forming system records a corresponding grayscale image on the back side of the surface to be foamed. The density of the grayscale image corresponds to a foaming height. The foaming height at the surface is controlled by controlling the image density.

Japanese Patent Application Laid-Open No. 2020-001392 discusses adjusting the edge density of a grayscale image to control the edge steepness of the foamed surface.

Japanese Patent Application Laid-Open No. 2019-155878 discusses applying a foaming inhibition component to a recording medium containing a vinyl chloride resin as a foaming agent, whereby the foaming of the foaming agent in the recording medium is inhibited.

### SUMMARY

According to an aspect of the present disclosure, an image processing apparatus includes an application unit configured to apply a foaming promotion component to a recording medium including a foaming layer containing foamable particles to foam, wherein the foaming promotion component is configured to promote foamability of the foamable particles, a foaming unit configured to foam the foamable particles by applying energy to the recording medium to which the foaming promotion component is applied by the application unit, an acquisition unit configured to acquire foaming data where a gradation value for applying the foaming promotion component is set for each pixel, a detection unit configured to detect an inner edge pixel based on the foaming data, wherein the inner edge pixel is located inside a border of a foaming region where the foamable particles are foamed with a non-foaming region where the foamable particles are not foamed, and a generation unit configured to generate the gradation value so that an amount of application of the foaming promotion component to the inner edge pixel detected by the detection unit increases compared to an amount of application of the foaming promotion component indicated by the foaming data acquired by the acquisition unit.

Further features of the present disclosure will become apparent from the following description of exemplary embodiments with reference to the attached drawings.

### BRIEF DESCRIPTION OF THE DRAWINGS

FIG. 1 is a diagram for describing a recording apparatus.

FIG. 2 is a diagram for describing a configuration of a recording system.

FIGS. 3A and 3B are diagrams for describing a configuration of a recording head.

FIG. 4 is a diagram for describing a recording medium.

FIGS. 5A and 5B are graphs for describing foaming height control.

FIG. 6 is a diagram for describing processing of foaming data.

FIGS. 7A to 7C are diagrams for describing edge detection.

FIGS. 8A and 8B are diagrams for describing the overlapping of dots.

FIG. 9 is a diagram for describing image processing of a color image.

FIG. 10 is a flowchart of image processing.

FIGS. 11A to 11C are diagrams for describing edge detection.

FIG. 12 is a diagram for describing the overlapping of dots.

FIG. 13 is a diagram for describing the overlapping of dots.

### DESCRIPTION OF THE EMBODIMENTS

A first exemplary embodiment of the present disclosure will be described below with reference to the drawings. The following exemplary embodiment describes a plurality of features. However, all of the features are not necessarily essential to the present disclosure, and some of the features may be freely combined. In the attached drawings, the same or similar components are denoted by the same reference numerals, and a redundant description thereof will be omitted.

### <Overview of Recording Apparatus>

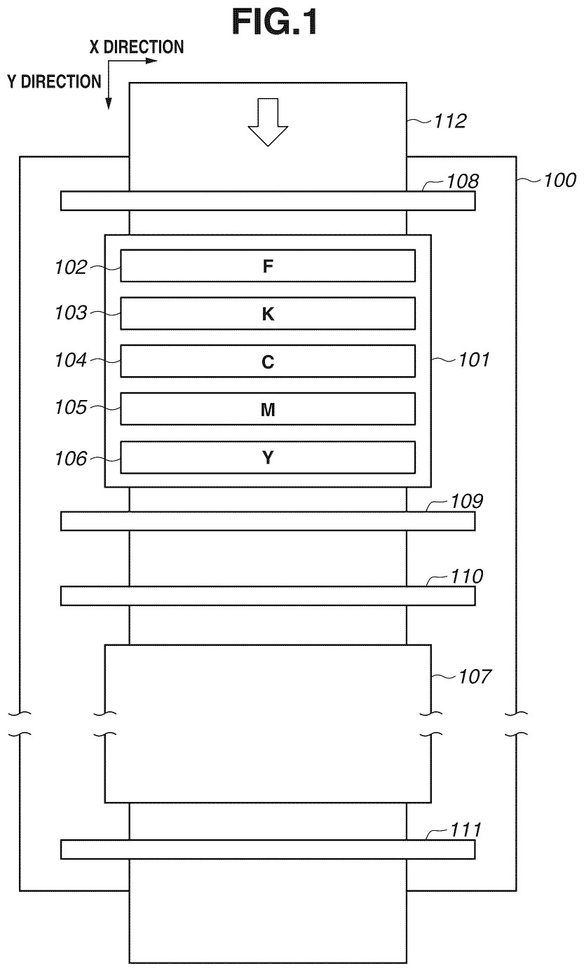

FIG. 1 is a schematic diagram illustrating a configuration of a recording apparatus 100 according to the present exemplary embodiment. Conveyance rollers 108, 109, 110, and 111 are each paired with a not-illustrated conveyance roller to sandwich a recording medium 112 therebetween, and convey the recording medium 112 in a Y direction illustrated in FIG. 1.

A recording unit 101 according to the present exemplary embodiment records an image on the recording medium 112 by applying ink using an inkjet (IJ) recording method for discharging ink. A recording head 102 discharges foaming control ink (F ink) containing a foaming control component. A recording head 103 discharges black (K) ink. A recording head 104 discharges cyan (C) ink.

A recording head 105 discharges magenta (M) ink. A recording head 106 discharges yellow (Y) ink. The recording medium 112 is conveyed in the Y direction, and each recording head includes a plurality of nozzles for discharging ink in an X direction intersecting the Y direction. In the present exemplary embodiment, the recording heads 102, 103, 104, 105, and 106 are arranged in this order upstream to downstream in the Y direction in the diagram. The inks are therefore applied to the recording medium 112 in order of F, K, C, M, and Y. The inks containing K, C, M, and Y color materials will be referred to collectively as “color inks”.

A heating unit 107 heats the recording medium 112 and the inks applied to the recording medium 112.

As will be described in detail below, the present exemplary embodiment uses a foaming promotion liquid containing a foaming promotion component as the foaming control ink. If the recording medium 112 contains foamable particles that foam thermally, regions where the foaming promotion liquid is applied foam due to the heat from the heating unit 107. The color inks applied to the recording medium 112 are fixed to the surface of the recording medium 112 as the moisture in the inks evaporates due to the heat provided by the heating unit 107, regardless of the type of the recording medium 112.

### <Overview of Configuration of Recording System>

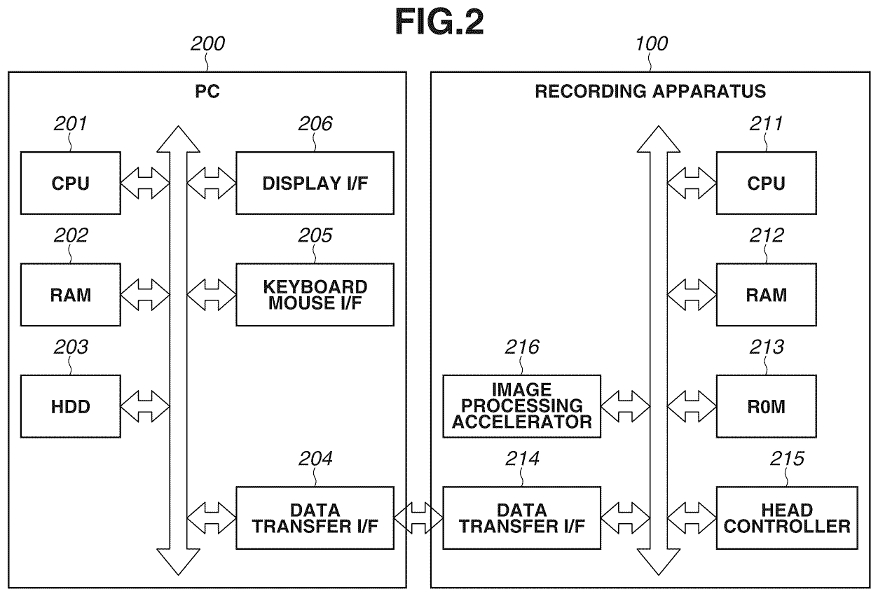

FIG. 2 is a block diagram illustrating a control configuration of a recording system including the recording apparatus 100 illustrated in FIG. 1 and a host apparatus connected to the recording apparatus 100. As illustrated in FIG. 2, this recording system includes the recording apparatus 100 illustrated in FIG. 1 and a personal computer (PC) 200 serving as the host apparatus.

The PC 200 includes a central processing unit (CPU) 201, a random access memory (RAM) 202, a hard disk drive (HDD) 203, a data transfer interface (I/F) 204, a keyboard mouse I/F 205, and a display I/F 206.

The CPU 201 performs processing based on programs stored in the HDD 203 and the RAM 202. The RAM 202 is a volatile storage, and temporarily stores programs and data. The HDD 203 is a nonvolatile storage, and also stores programs and data. The data transfer I/F 204 controls data transmission and reception to/from the recording apparatus 100. As the data transmission and reception method, wired connections such as Universal Serial Bus (USB), Institute of Electrical and Electronics Engineers (IEEE) 1394, and a local area network (LAN), and wireless connections such as Bluetooth® and Wireless Fidelity (Wi-Fi) can be used. The keyboard mouse I/F 205 is an I/F for controlling a user interface (UI) such as a keyboard and a mouse. The user can input information to the PC 200 via the keyboard mouse I/F 205. The display I/F 206 controls display on a display (not illustrated).

The recording apparatus 100 includes a CPU 211, a RAM 212, a read-only memory (ROM) 213, a data transfer I/F 214, a head controller 215, and an image processing accelerator 216.

The CPU 211 performs processing of each exemplary embodiment described below based on programs stored in the ROM 213 and the RAM 212. The RAM 212 is a volatile storage, and temporarily stores programs and data. The ROM 213 is a nonvolatile storage, and stores table data and programs for use in the processing of each exemplary embodiment described below. The data transfer I/F 214 controls data transmission and reception to/from the PC 200.

The head controller 215 controls a recording operation of the recording heads 102 to 106 of the recording unit 101 based on recording data. Specifically, the head controller 215 is configured to read control parameters and recording data from a predetermined address of the RAM 212.

More specifically, when the CPU 211 writes the control parameters and recording data to the predetermined address of the RAM 212, the head controller 215 initiates processing and the recording heads 102 to 106 perform the recording operation.

The image processing accelerator 216 is implemented by hardware and performs image processing faster than the CPU 211. Specifically, the image processing accelerator 216 is configured to read parameters and data for the image processing from a predetermined address of the RAM 212. When the CPU 211 writes the parameters and data to the predetermined address of the RAM 212, the image processing accelerator 216 is activated to perform predetermined image processing.

Note that the image processing accelerator 216 is not an essential component. Depending on the specifications of the recording apparatus 100, the predetermined image processing may be performed by the CPU 211 alone.

### <Overview of Configuration of Recording Heads>

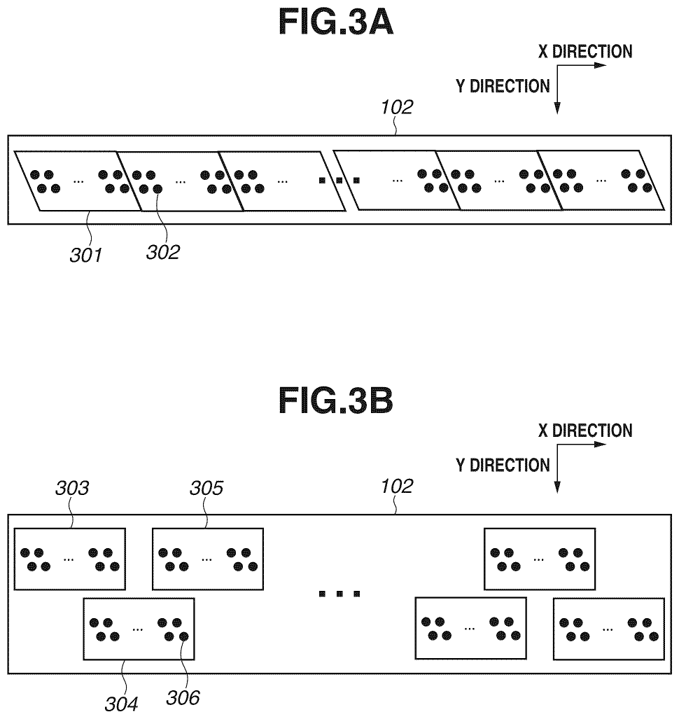

FIGS. 3A and 3B are schematic views illustrating a configuration of the recording head 102. The recording head 102 illustrated in FIG. 3A includes a plurality of recording chips 301. Each recording chip 301 includes a plurality of recording nozzles 302. The recording chip 301 includes a circuit that drives recording elements for discharging ink from the recording nozzles 302. Examples of the recording elements include heater elements and piezoelectric elements. The recording nozzles 302 are arranged in two rows in the Y direction as a set. The recording nozzles 302 in each recording nozzle row are arranged at a pitch of 600 dpi in the X direction. The two recording nozzle rows are staggered by 1200 dpi in the X direction. Each recording chip 301 includes three sets of two recording nozzle rows in the Y direction (not illustrated).

A plurality of recording chips 301 is arranged in the X direction, so that two recording chips 301 and the recording nozzles 302 in the same rows of the recording chips 301 are arranged at a pitch of 600 dpi. Each recording nozzle row in each recording chip 301 includes 600 recording nozzles 302 arranged in the X direction. In other words, a single recording chip 301 has a recording width of 1 inch in the X direction. An image is formed on a recording medium 112 by applying the foaming control ink discharged from the recording nozzles 302 using the IJ method. The recording head 102 according to the present exemplary embodiment includes 13 recording chips 301 arranged in the X direction, and can record an image of 13 inches in width, i.e., approximately 330 mm in width in the X direction. The recording resolution in the X direction is 1200 dpi. The discharge frequency, or the number of times each recording nozzle 302 can discharge ink per second, is controlled to 10 kHz. The recording resolution in the Y direction is controlled to be 1200 dpi by conveying the recording medium 112 at approximately 8.33 inch/see in the Y direction. As described above, each recording chip 301 includes a set of two rows of recording nozzles 302 arranged in the Y direction, and the two recording nozzle rows are staggered by 1200 dpi in the X direction.

The recording nozzles 302 in each of the rows are arranged at a pitch of 600 dpi in the X direction. Three sets of such recording nozzle rows are disposed in the Y direction so that up to three ink droplets can be applied to the same pixel in the Y direction.

The recording heads 103, 104, 105, and 106 have a configuration similar to that of the recording head 102 in FIG. 3A describe above. A description thereof will thus be omitted. The F, C, M, Y, and K inks are applied to the recording medium 112 in a size of 2 pl per droplet. The F, C, M, Y, and K inks are each adjusted to 2 ng for 2 pl. Each ink can be applied to a 1200-dpi square pixel up to three droplets, or equivalently, up to 6 pl, or 6 ng.

FIG. 3B is a diagram illustrating another configuration example of the recording head 102. The recording head 102 includes recording chips 303, 304, and 305. The recording chips 303 to 305 each include a plurality of recording nozzles 306. Two recording nozzle rows are arranged in the Y direction, each including a plurality of recording nozzles 306 arranged at a pitch of 600 dpi in the X direction. The two recording nozzle rows are staggered by 1200 dpi in the X direction. The recording chips 303 to 305 are arranged in the X and Y directions in a staggered pattern. The recording chips 303 and 304 are located so that two rows of two pixels at the right end of the recording chip 303 and two rows of two pixels at the left end of the recording chip 304 overlap in the X direction. The recording chip 304 is offset in the +Y direction to not physically overlap the recording chip 303. Similarly, the recording chips 304 and 305 are located so that two rows of two pixels at the right end of the recording chip 304 and two rows of two pixels at the left end of the recording chip 305 overlap in the X direction. The recording chip 305 is offset in the −Y direction to not physically overlap the recording chip 304. The layout illustrated in FIG. 3B is implemented by repeatedly arranging recording chips 304 with respect to recording chips 305 in the same manner as the recording chip 304 is with respect to the recording chip 303. The discharge frequencies of the overlapping recording nozzles 306 are dispersed at a predetermined ratio so that ink is not applied to the same region of the recording medium 112.

In FIG. 3A, the recording nozzles 302 of the recording chips 301 do no overlap. However, the recording nozzles 302 may be configured to overlap. The discharge frequencies of the overlapping recording nozzles 302 are desirably dispersed at a predetermined ratio so that ink is not applied to the same region of the recording medium 112.

### <Recording Medium Including Foaming Layer>

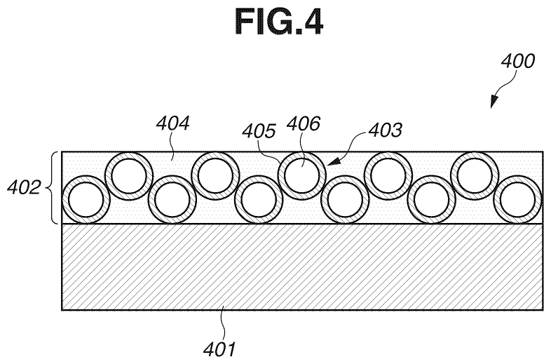

FIG. 4 is a sectional view schematically illustrating a recording medium used to form a three-dimensional image according to the present exemplary embodiment. A recording medium 400 includes a base 401 and a foaming layer 402 on the base 401.

The base 401 functions as a support for supporting the foaming layer 402. The type of the base 401 is not limited in particular. Examples of the base 401 may include paper made from ordinary natural pulp, kenaf paper, and plastic film sheets such as polypropylene, polyethylene, and polyester sheets. Other examples include synthetic paper or nonwoven fabrics that are paper-like materials made of synthetic fibers, synthetic pulp, or synthetic resin films.

The foaming layer 402 is located on at least one surface of the base 401, and contains foamable particles 403 and a binder resin 404. The foamable particles 403 are thermally foamable microcapsules, each including a capsular shell layer containing a thermoplastic resin and a volatile material 406 encapsulated in the shell layer 405. When the foamable particles 403 are heated, the thermoplastic resin constituting the shell layers 405 softens and the volatile material 406 encapsulated in the shell layers 405 vaporizes. Such a balloon-like increase in the volume of the foamable particles 403 is referred to as foaming.

Examples of the thermoplastic resin contained in the shell layers 405 may include the following: polystyrene, styrene-acrylic ester copolymer, polyamide resin, polyacrylic ester, polyvinylidene chloride, polyacrylonitrile, and polymethyl methacrylate. Other examples include vinylidene chloride-acrylonitrile, methacrylic ester-acrylic acid copolymer, vinylidene chloride-acrylic acid copolymer, and vinylidene chloride-acrylic ester copolymer.

Examples of the volatile material 406 may include the following: ethane, ethylene, propane, propene, n-butane, isobutane, n-pentane, isopentane, neopentane, n-hexane, heptane, and petroleum ether. Other examples include chlorofluorocarbons such as CCl₃F, CCl₂F₂, CClF₃, and CClF₂—CClF₂. Other examples include tetraalkylsilanes such as tetramethylsilane, trimethylethylsilane, trimethylisopropylsilane, and trimethyl-n-propylsilane. The volatile material 406 is desirably a hydrocarbon with a molecular weight of 120 or less. The lower limit of the molecular weight of the volatile material 406 is not limited in particular, but is desirably 50 or more, for example. The content of the foamable particles 403 in the foaming layer 402 is desirably 5 mass % or more and 95 mass % or less.

The foaming layer 402 contains the binder resin 404 for enhancing adhesion to the base 401. The binder resin 404 is used to prevent the exfoliation of the foaming layer 402 from the base 401 when the foamable particles 403 in the foaming layer 402 are thermally foamed. A water-insoluble resin is used as the binder resin 404. Since the water-insoluble resin is less likely to be dissolved by the water in the foaming promotion liquid serving as the foaming control ink, a degradation in adhesion between the foaming layer 402 and the base 401 due to the foaming promotion liquid can be prevented. For the same reason, a degradation in adhesion between the foaming layer 402 and the base 401 can be prevented even when water-based inks containing water are applied to the recording medium 112.

The water-insoluble resin refers to a resin 95 mass % or more of which remains after immersed in warm water of 80° C. for two hours. The water-insoluble resin is desirably at least one selected from a group including acrylic resins and urethane resins. The water-insoluble resin is more desirably at least one selected from a group including acrylic resins free of ester groups and urethane resins free of ester groups. The water-insoluble resin is desirably a non-water-absorbing resin. The content of the water-insoluble resin in the foaming layer 402 is desirably 10 mass % or more and 95 mass % or less with respect to the total mass of the foaming layer 402. Aside from the water-insoluble resin, the foaming layer 402 may also contain a water-soluble resin within the extent where the effects of the present exemplary embodiment can be obtained. The binder resin 404 desirably has a glass transition temperature of −10° C. or higher and 30° C. or lower. The glass transition temperature of the binder resin 404 within the foregoing range can prevent the binder resin 404 from interfering with the foaming of the foamable particles 403.

The mass ratio of the foamable particles 403 and the binder resin 404 is desirably (foamable particles):(binder resin)=5:95 to 90:10. The mass ratio of the foamable particles 403 and the binder resin 404 within the foregoing range can improve both the foamability of the foamable particles 403 and the adhesion of the binder resin 404 to the base 401. The foaming layer 402 may further contain components such as pigments, antioxidants, dyes, and surfactants within the extent where the foamability is not impaired.

### <Foaming Control Ink>

Next, details of the foaming promotion liquid used as the foaming control ink in the present exemplary embodiment will be described. The foaming promotion liquid contains a foaming promotion component that lowers the foaming start temperature of the foamable particles 403. Applying the foaming promotion liquid to the foaming layer 402 of the recording medium 112 by IJ-based discharging or application softens the thermoplastic resin contained in the shell layers 405 of the foamable particles 403. This is considered to shift the foaming start temperature and the maximum foaming temperature of the foamable particle 403 to lower temperatures.

The foaming promotion component may be any compound that softens the thermoplastic resin contained in the shell layers 405 of the foamable particles 403 and is free of a hydroxyl group. An appropriate compound can be selected and used depending on the type of thermoplastic resin. Examples of the foaming promotion component may include 2-pyrrolidone, dimethyl sulfoxide, N,N-dimethylformamide, and N-methyl-2-pyrrolidone. The hydroxyl-free compound serving as the foaming promotion component desirably has a boiling point higher than the temperature at which the foaming layer 402 is heated. When the foaming layer 402 is heated, the compound having the boiling point higher than the heating temperature of the foaming layer 402 will not vaporize and can contribute to the softening of the thermoplastic resin in the shell layers 405 of the foamable particles 403. The content of the hydroxyl-free compound serving as the foaming promotion component is desirably 10 mass % or more and 70 mass % or less with respect to the total mass of the foaming promotion liquid.

The absolute value of a difference between the solubility parameter (SP1) of the thermoplastic resin forming the shell layers 405 of the foamable particles 403 that are microcapsules and the solubility parameter (SP2) of the foaming promotion component, |SP1−SP2|, is desirably less than or equal to 3.5. The absolute value of the difference between the solubility parameters within the foregoing numerical range can further improve the foamability of the regions of the foaming layer 402 where the foaming promotion liquid containing the foaming promotion component is applied.

The absolute value of a difference between the Hansen solubility parameter (HSP1) of the thermoplastic resin forming the shell layers 405 of the foamable particles 403 and the Hansen solubility parameter (HSP2) of the foaming promotion component, |HSP1−HSP2|, is desirably less than or equal to 20. The absolute value of the difference between the Hansen solubility parameters within the foregoing numerical range can further improve the foamability of the regions of the foaming layer 402 where the foaming promotion liquid containing the foaming promotion component is applied.

The solubility parameters (SP values) of the thermoplastic resin forming the shell layers 405 and the foaming promotion component are both values calculated by computation. The Hansen solubility parameters (HSP values) of the thermoplastic resin forming the shell layers 405 and the foaming promotion component are both actual measurements measured and calculated using dynamic light scattering.

If the foaming promotion component is liquid at room temperature (25° C.), the foaming promotion component itself may be used as the foaming promotion liquid. The foaming promotion liquid may further contain components other than the foaming promotion component. For example, to improve the discharge stability of the foaming promotion liquid, the foaming promotion liquid may further contain a liquid component such as a solvent. Water and various types of water-soluble organic solvents can be used as the solvent. For water, deionized water (ion-exchanged water) is desirably used. Examples of the water-soluble organic solvents may include alcohols, glycols, glycol ethers, and nitrogen-containing compounds.

For components other than the liquid component, water-soluble organic compounds that are solid at a temperature of 25° C., such as urea and its derivatives, trimethylolpropane, and trimethylolethane, can be used. The foaming promotion liquid may further contain various additives including pH adjusting agents, defoaming agents, rust inhibitors, preservatives, antifungal agents, antioxidants, anti-reducing agents, and chelating agents as appropriate.

### <Control of Foaming Height>

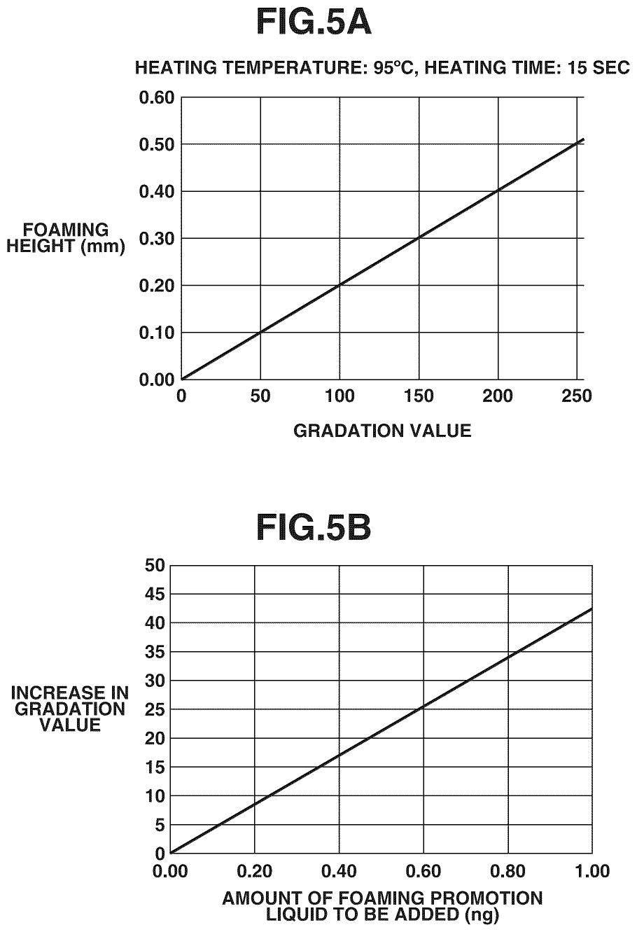

FIGS. 5A and 5B are graphs illustrating a relationship between the amount of application of the foaming promotion liquid to the recording medium 400 including the foaming layer 402, a gradation value for controlling the amount of application, and a foaming height. FIG. 5A is a graph illustrating the relationship of the foaming height to the gradation value corresponding to the amount of application of the foaming promotion liquid to the recording medium 400 including the foaming layer 402. The horizontal axis of the graph indicates the gradation value corresponding to the amount of application of the foaming promotion liquid for a 1200-dpi square pixel. The vertical axis indicates the foaming height of the 1200-dpi square pixel heated by the heating unit 107 at a heating temperature of 95° C. for a heating time of 15 sec. The foaming height of the foaming layer 402 can be controlled based on the gradation value corresponding to the amount of application of the foaming promotion liquid.

### <Foaming Data Processing>

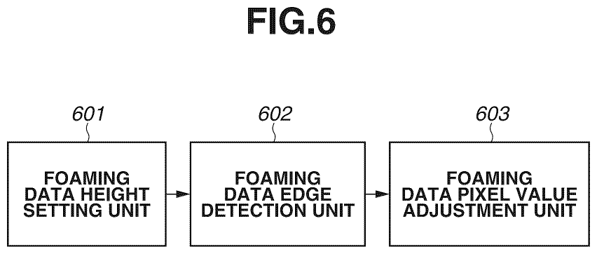

FIG. 6 is a block diagram for describing foaming data processing in applying the foaming promotion liquid to the recording medium 400 including the foaming layer 402. The foaming data processing of this diagram is performed by the PC 200.

A foaming data height setting unit 601 sets the gradation value corresponding to a desired foaming height. Foaming data is input as 8-bit α-channel data with a resolution of 1200 dpi, aside from respective 8-bit red, green, and blue (RGB) data of a color image to be described below. The foaming data will be referred to as α data. The desired foaming height is set via a UI displayed on the display (not illustrated) connected to the display I/F 206, by operating the keyboard and mouse connected to the keyboard mouse I/F 205. For example, a user-desired maximum foaming height value is accepted via the UI.

The foaming data height setting unit 601 sets the gradation value corresponding to the user-desired maximum foaming height value based on the graph of FIG. 5A. Here, a case where a foaming height of 0.4 mm is set using the UI will be described as an example. Referring to the graph of FIG. 5A, the gradation value corresponding to the foaming height of 0.4 mm can be derived to be 200. The foaming data height setting unit 601 detects the maximum value in the acquired α data. The foaming data height setting unit 601 then configures settings so that the detected maximum value corresponds to the gradation value for the maximum foaming height value set using the UI, i.e., 200. The input α data is converted into α′ data based on (Eq. 1):

α′=α×(gradation value for desired height)÷(maximum value detected). (Eq. 1)

For example, if the maximum value detected in the α data is 150, the α data is replaced with values converted by the following (Eq. 1′):

$${α}^{′} = α \times 200 \div 150. \qquad ( Eq . {1}^{′} )$$

If the maximum value detected in the α data is 255, the α data is placed with values converted by the following (Eq. 1″):

$${α}^{′} = α \times 200 \div 255. \qquad ( Eq . {1}^{″} )$$

In the present exemplary embodiment, the conversion includes rounding off decimal places into the nearest integer. The handling of decimal places is not limited thereto, and the decimal places may be discarded or rounded up.

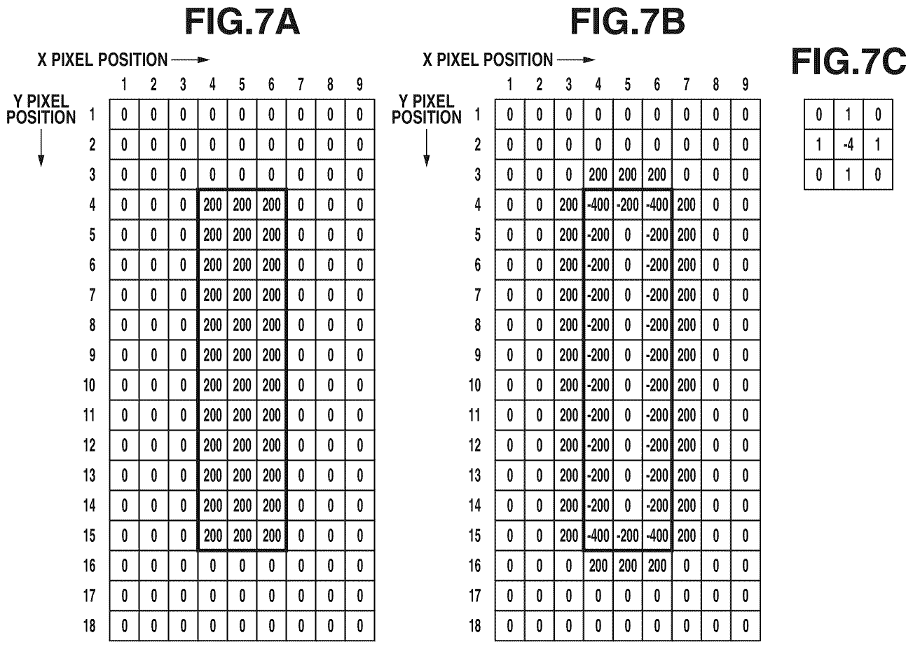

Return to FIG. 6. A foaming data edge detection unit 602 detects edges in the α′ data. FIGS. 7A to 7C are diagrams for describing the edge detection performed by the foaming data edge detection unit 602. FIG. 7A illustrates a portion of the α′ data, a region of nine pixels in the X direction and 18 pixels in the Y direction. In this diagram, the region of three pixels in the X direction and 12 pixels in the Y direction, surrounded by the thick black frame, is a “foaming region”, where each pixel has a gradation value of 200. The region outside the foaming region surrounded by the thick black frame, where each pixel has a gradation value of 0, is a “non-foaming region”. In the present exemplary embodiment, an edge refers to a border between foaming and non-foaming regions. In FIG. 7A, edges correspond to the thick black frame.

FIG. 7B is a diagram illustrating the result of the edge detection processing performed on FIG. 7A. FIG. 7C is a diagram illustrating a Laplacian filter with a size of 3×3 pixels to be used for the edge detection processing. The edge detection processing will now be described. The center pixel of the Laplacian filter in FIG. 7C is associated with a pixel of interest in FIG. 7A. The eight pixels of the Laplacian filter in FIG. 7C excluding the center pixel are associated with the eight peripheral pixels adjoining the pixel of interest in FIG. 7A. The pixel values of FIG. 7A are multiplied by the respective pixel values (coefficients) of the Laplacian filter in FIG. 7C. The nine products are added, and the resulting numerical value is used as the value of the pixel of interest in FIG. 7B corresponding to the pixel of interest in FIG. 7A.

In FIG. 7B, pixels that adjoin the thick black frame and fall within the foaming region surrounded by the thick black frame will be referred to as inner edge pixels. Pixels that adjoin the thick black frame and fall outside the foaming region surrounded by the thick black frame will be referred to as outer edge pixels. The inner edge pixels have negative values. The outer edge pixels have positive values.

In other words, if the sign of a value calculated by the edge detection processing is negative, the pixel can be determined as being an inner edge pixel. If the sign is positive, the pixel can be determined as being an outer edge pixel. In the present exemplary embodiment, inner edge pixels are detected as edge pixels since the foaming promotion liquid is used for recording. In the present exemplary embodiment, one pixel inside an edge is detected as an inner edge pixel. However, two or more pixels inside may be detected as inner edge pixels.

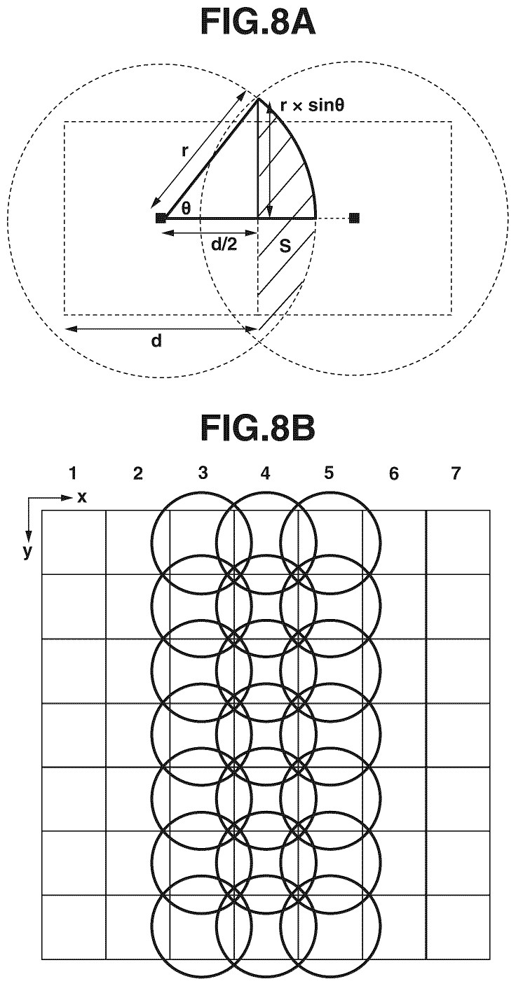

Return to FIG. 6. A foaming data pixel value adjustment unit 603 adjusts the pixel values of the edge pixels. FIGS. 8A and 8B are diagrams illustrating overlapping of dots when the foaming promotion liquid is applied to the recording medium 112. FIG. 8A is a diagram illustrating the overlapping of dots of the foaming promotion liquid applied to two adjoining pixels. The overlapping area the two dots on either one of the two pixels, indicated by diagonal lines in FIG. 8A, is calculated by the following (Eq. 2) and (Eq. 3):

$$θ = {cos}^{- 1} ( d / 2 r ) , and \qquad ( Eq . 2 )$$

$$S = ( ( π {r}^{2} \times θ / 360 ) - ( d \times r \times sin θ / 4 ) ) \times 2 , \qquad ( Eq . 3 )$$

where r: the radius of a dot,
d: the length of one side of a pixel,
θ: an angle between the straight line connecting the center point of the dot with an intersection of the two dots and the straight line connecting the center points of the two pixels, and
S: the overlapping area of the two dots on either one of the two pixels.

FIG. 8B is a diagram illustrating a few columns of seven pixels in the Y direction where dots overlap one another in a case where the foaming promotion liquid is applied to a region of three consecutive pixels in the X direction and seven consecutive pixels in the Y direction. Seven pixels arranged in the Y direction will be referred to a column. Columns 1 to 7 are defined in order in the X direction from the left in the diagram.

Each of the pixels in column 4 not only undergoes the dot of the foaming promotion liquid applied to the pixel but also overlaps the dots of the foaming promotion liquid applied to the adjoining pixels in columns 3 and 5.

By contrast, each of the pixels in column 3 overlaps the dot of the foaming promotion liquid applied to the adjoining pixel in column 4. Each of the pixels in column 5 overlaps the dot of the foaming promotion liquid applied to the adjoining pixel in column 4. In other words, the amount of the foaming promotion liquid on each of the pixels in columns 3 and 5 is less than that of the foaming promotion liquid on each of the pixels in column 4 as much as corresponding to the area S of dot overlap in FIG. 8A. In the present exemplary embodiment, the amount of the foaming promotion liquid to be applied to each of the pixels in columns 3 and 5, which correspond to inner edge pixels detected, is therefore increased to reduce the difference from the amount of the foaming promotion liquid corresponding to the area S.

For ease of description, it is assumed that the applied foaming promotion liquid spreads uniformly over a single dot area πr². It is also assumed that the amount of the foaming promotion liquid applied to a single dot is V ng. The amount of ink ΔV ng for each pixel in columns 3 and 5 to be compensated for is calculated by the following (Eq. 4):

$$Δ V = V \times ( S / π {r}^{2} ) . \qquad ( Eq . 4 )$$

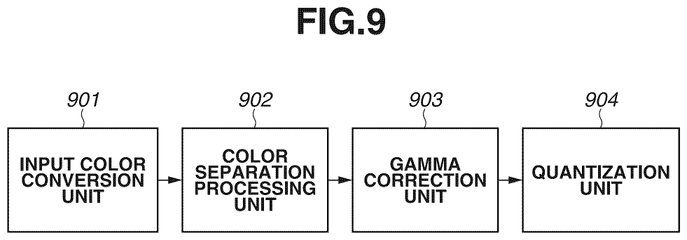

In the present exemplary embodiment, binary data indicating whether to form dots is generated. If a dot is formed, the amount of application of the foaming promotion liquid is V ng. If a dot is not formed, the amount of application of the foaming promotion liquid is 0 ng. In the pixel group of column 3 and the pixel group of column 5, pixels to increase the foaming promotion liquid for and pixels to not increase the foaming promotion liquid for are then controlled so that the foaming promotion liquid is added by an average of V×(S/πr²) ng per pixel. A quantization unit 904 of FIG. 9 to be described below generates the foregoing binary data indicating whether to apply the foaming promotion liquid, based on the gradation values of the pixels.

FIG. 5B is a graph illustrating the increment in the gradation value with respect to the amount of the foaming promotion liquid to be added. Based on this graph, the increment in the gradation value is determined from the amount of the foaming promotion liquid to be added. The foaming data pixel value adjustment unit 603 adds the determined increment in the gradation value to the gradation values of the respective pixels in columns 3 and 5. The adjusted gradation values will be referred to as α″ data.

Based on the α″ data generated by the foregoing processing, pixels to apply the foaming promotion liquid to are determined by quantization processing to be described below. The use of the adjusted α″ data increases the amount of the foaming promotion liquid to be applied to each of the pixels in columns 3 and 5, which are inner edge pixels of the foaming region, compared to the case where the unadjusted α data is used for the quantization processing. As a result, the foaming height of the inner edge pixels based on the α″ data can be made higher than the foaming height of the inner edge pixels based on the α′ data.

Since the foaming promotion liquid applied does not necessarily spread uniformly over the dot area, the amount of the foaming promotion liquid to be added may be determined by experiment instead of using the foregoing calculation method.

For example, the amount of the foaming promotion liquid to be added to an inner edge pixel may be determined by experiment for each unadjusted gradation value, and tabulated in advance. The table prepared in advance is referred to determine the amount of the foaming promotion liquid to be added from the unadjusted gradation value of an inner edge pixel. The increment in the gradation value is then determined from the amount of the foaming promotion liquid to be added in FIG. 5B, whereby the gradation value of the inner edge pixel may be adjusted.

Increasing the dots of the foaming promotion liquid on the pixels in column 3 or 5 of FIG. 8B, which correspond to inner edge pixels, increases the amount of the foaming promotion liquid on each of the pixels in column 4 as much as corresponding to the area S. Consequently, the difference between the amount of the foaming promotion liquid in column 3 or 5 and the amount of the foaming promotion liquid in column 4 does not decrease as much as desired. In view of this, the increment in the gradation value on the vertical axis of FIG. 5B may be modified. The increment in the gradation value may be set to be greater. The increment in the gradation value may be determined by experiment so that a degradation in the visibility of the foaming region decreases, and the graph of FIG. 5B may thereby be prepared in advance.

Depending on the value indicating the foaming height set via the user UI, the α′ data can be converted into 255 by the foaming data height setting unit 601. Since 255 is the maximum 8-bit value, the foaming data pixel value adjustment unit 603 is unable to increase the gradation values of inner edge pixels beyond 255. In such a case, the α′ data may be limited to less than 255. For example, the upper limit value for the foaming height that can be set on the UI is set to equal to or less than a foaming height of 0.51 mm corresponding to the gradation value of 255 in FIG. 5A. This can limit the foaming height set on the UI so that the gradation values of the inner edge pixels fall within 255 even after the addition of the increment.

### <Image Processing of Color Image to be Recorded by Recording Apparatus>

FIG. 9 is a block diagram for describing the image processing of a color image according to the present exemplary embodiment. The image processing illustrated in this block diagram is performed by the recording apparatus 100 of FIG. 2. An input color conversion unit 901 receives RGB multivalued data, eight bits for each color, with a resolution of 1200 dpi. The input color conversion unit 901 generates R′G′B′ multivalued data, eight bits for each color, by converting the RGB data into the color gamut of the recording apparatus 100.

This data conversion is performed using a conventional technique such as matrix operation processing and three-dimensional lookup table (3DLUT) processing. As employed herein, a 3DLUT refers to a table storing combinations of input RGB data and converted R′G′B′ data. For example, if the table stores data on each of the R, G, and B colors in 16 levels consisting of 0, 17, 34, . . . , 221, 238, and 255 out of multiple values of 0 to 255, the table contains 16×16×16=4096 combinations. If a value satisfying a combination, i.e., RGB data falling on a lattice point is input, the corresponding R′G′B′ data on the table is output. If a value satisfying none of the combinations on the table, i.e., RGB data not falling on a lattice point is input, the R′G′B′ data is calculated by arithmetic processing such as conventional tetrahedral interpolation, using four neighboring combinations.

A color separation processing unit 902 performs color separation processing on the R′G′B′ data to generate multivalued data on CMYK color inks of the recording apparatus 100, eight bits for each color. This color separation processing can be performed using a conventional technique such as matrix operation processing and 3DLUT processing.

A gamma correction unit 903 generates C′M′Y′K′ multivalued data, 12 bits for each color, by correcting the CMYK data so that the brightness of the image recorded on the recording medium 112 by the recording apparatus 100 changes linearly. This correction processing can be performed using a one-dimensional lookup table (1DLUT).

The quantization unit 904 generates quantization data by performing quantization processing on the C′M′Y′K′ data. The quantization processing can be performed using a conventional dithering method or error diffusion method. In the present exemplary embodiment, the generated quantization data is quaternary data on each of the C, M, Y, and K ink colors, with two bits per pixel of 1200 dpi. The quantization data on each color indicates that no ink droplet is to be discharged with a value of 0. The quantization data indicates that one ink droplet is to be discharged with a value of 1, two ink droplets with a value of 2, and three ink droplets with a value of 3.

The quantization unit 904 also quantizes the data on the foaming promotion liquid, generated by the foaming data pixel value adjustment unit 603, into quaternary data with two bits per pixel of 1200 dpi. The correspondence between the value of the quantization data and the number of droplets of the foaming promotion liquid to be discharged is the same as those of the color inks.

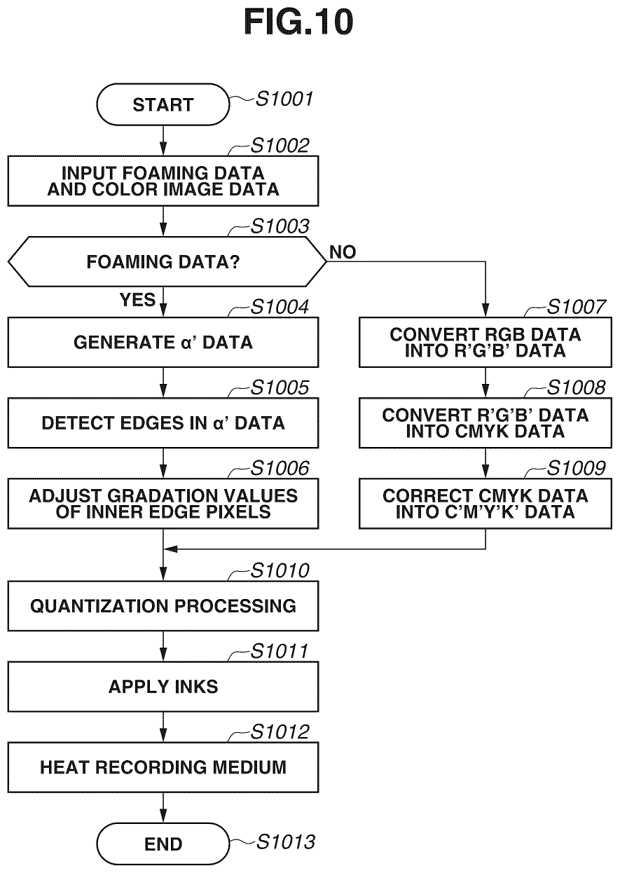

FIG. 10 is a flowchart for describing the image processing and recording processing according to the present exemplary embodiment. In the present exemplary embodiment, steps S1001 to S1006 are performed by the PC 200, and steps S1007 and beyond are performed by the recording apparatus 100. However, all the processing may be performed by the recording apparatus 100. Part of the processing may be performed by the recording apparatus 100 and the PC 200 in a shared manner.

In step S1001, the processing of this flowchart starts. In step S1002, the user inputs foaming data and color image data into the PC 200. In step S1003, the PC 200 determines whether acquired data is foaming data. The determination is made by the CPU 201 executing a program stored in the HDD 203. Whether the acquired data is foaming data can be determined based on whether the data is α data on the α channel. If the acquired data is determined to be foaming data (YES in step S1003), the processing proceeds to step S1004. If the acquired data is not foaming data (NO in step S1003), the acquired data is determined to be a color image, i.e., RGB data and the processing proceeds to step S1007.

In the present exemplary embodiment, in step S1003, the PC 200 determines, at the same time, whether the resolution of the α data that is the foaming data is 1200 dpi. If the resolution is not 1200 dpi, the α data is converted into a resolution of 1200 dpi using a nearest neighbor method. While bilinear and bicubic methods may be used for the resolution conversion processing, the present exemplary embodiment uses the nearest neighbor method for the purpose of maintaining the sharpness of the edges of foaming regions in the α data.

Similarly, in step S1003, if the resolution of the RGB data that is color image data is not 1200 dpi, the resolution is converted using a conventional resizing method such as the nearest neighbor, bilinear, and bicubic methods. For the purpose of avoiding the occurrence of jaggies and reducing a drop in sharpness, the resolution is desirably converted using the bicubic method.

In a case where the input data is the forming data in step S1003, then in step S1004, the foaming data height setting unit 601 generates α′ data based on the input α data by using the foregoing method. The present exemplary embodiment will be described on the assumption that the foaming height set by the user via the UI is 0.4 mm. From FIG. 5A, the gradation value corresponding to the foaming height of 0.4 mm is calculated to be 200. As illustrated in FIG. 7A, the gradation values in the foaming region of 3×12 pixels are converted based on the maximum gradation value in the α data and (Eq. 1). In the present exemplary embodiment, the maximum gradation value of the α data is 255, and the foaming height set by the user is 0.4 mm. The maximum value of the converted α′ data is thus 200.

In step S1005, the foaming data edge detection unit 602 detects edges in the α′ data. The edge detection processing is performed using the Laplacian filter of FIG. 7C. FIG. 7B illustrates the result of the edge detection processing. Since the present exemplary embodiment uses the foaming promotion component as the foaming control ink, inner edge pixels are detected as edge pixels.

In step S1006, the foaming data pixel value adjustment unit 603 adjusts the gradation value of each of the inner edge pixels in the foaming region, and sets the adjusted gradation value. The gradation values are adjusted for the purpose of adding the foaming promotion liquid as described with reference to FIGS. 5A, 5B, 8A, and 8B. In the present exemplary embodiment, r=15 μm, d=21.167 μm, and V=2 ng. Based on (Eq. 2) and (Eq. 3), S=64.705 μm² is calculated. Based on (Eq. 4), ΔV=0.183 ng is calculated for inner edge pixels. From FIG. 5B, the increment in the gradation value for adding the foaming promotion liquid to the inner edge pixels is calculated to be 7.7775.

Adding the increment in the gradation value, 7.7775, to the gradation value of the inner edge pixels in the α′ data, 200, yields 207.7775. The value is converted to a 12-bit integer value in preparation for the quantization processing. Here, 207.7775×16=3324.44.

By rounding off the decimal places, 12-bit α″ data of 3324 is calculated. The gradation values of the pixels in column 4 of the foaming region, 200, are converted by 200×16=3200, whereby 12-bit α″ data of 3200 is calculated.

Meanwhile, in step S1007, the input color conversion unit 901 converts the 8-bit RGB data into 8-bit R′G′B′ data. In step S1008, the color separation processing unit 902 converts the 8-bit R′G′B′ data into 8-bit CMYK data. In step S1009, the gamma correction unit 903 corrects the 8-bit CMYK data into 12-bit C′M′Y′K′ data.

In step S1010, the quantization unit 904 performs the quantization processing. The quantization unit 904 inputs the 1200-dpi 12-bit α″ data and the 1200-dpi 12-bit C′M′Y′K′ data. The quantization unit 904 generates 2-bit quaternary quantization data corresponding to the foaming control ink (F ink) that is the foaming promotion liquid. The ΔV value calculated in step S1006 is ΔV=0.183 ng, and V=2 ng. Compared to the case where the gradation values of the inner edge pixels are not adjusted, the number of dots of the foaming promotion liquid to be added is 0.183 ng÷2 ng=0.0915. In other words, an average of 0.0915 dots per pixel is added for the inner edge pixels. For the color image, 2-bit quaternary quantization data corresponding to each of the CMYK inks is generated.

In step S1011, the recording unit 101 applies the inks to the recording medium 112 based on the quantization data. For each ink color, quantization data of 0 corresponds to zero droplets of the ink, 1 to one droplet, 2 to two droplets, and 3 to three droplets. Up to three droplets of ink are thus applied to a single 1200-dpi pixel.

In step S1012, the heating unit 107 heats the recording medium 112 to which the inks are applied. Compared to the case where the gradation values of the inner edge pixels are not adjusted, the amount of application of the foaming control ink (F ink) to the inner edge pixels increases by an average of 0.0915 droplets per pixel, and the foaming heights of the inner edge pixels increase as well. The CMYK color inks are fixed to the recording medium 112 by the heating.

In step S1013, this processing ends.

As described above, in the present exemplary embodiment, the amount of application of the foaming control ink to the edges of foaming regions that foam to form a three-dimensional image is controlled so that the foaming height does not decrease. This can prevent a decrease in the foaming height of the edge portions compared to the center portions of the foaming regions. Moreover, the foaming height can be prevented from becoming lower than the user-desired foaming height, whereby a degradation in the visibility of the foaming regions can be prevented.

In the first exemplary embodiment, an example where the foaming promotion liquid containing the foaming promotion component is used as the foaming control ink has been described. A second exemplary embodiment deals with a case of using a foaming inhibition liquid containing a foaming inhibition component.

As described above, Japanese Patent Application Laid-Open No. 2019-155878 discusses a configuration that applies a foaming inhibition component to a recording medium containing a vinyl chloride resin as foamable particles and then heats to dry the recording medium, whereby the foaming of the foaming agent in regions where the foaming inhibition component is applied is inhibited. The amount of application of the foaming inhibition component is controlled to make the foaming height of the applied regions low and the foaming height of not-applied regions high.

In the present exemplary embodiment, a recording medium to which the vinyl chloride resin is applied as a foaming agent is used as a recording medium 112. Ink containing a foaming inhibition component for inhibiting the foaming of the vinyl chloride resin is used as the foaming control ink (Fink). The foaming inhibition liquid is applied from a recording head 102 to the recording medium 112. The recording method is similar to the method already described with reference to FIGS. 1, 2A, 2B, 3A, and 3B.

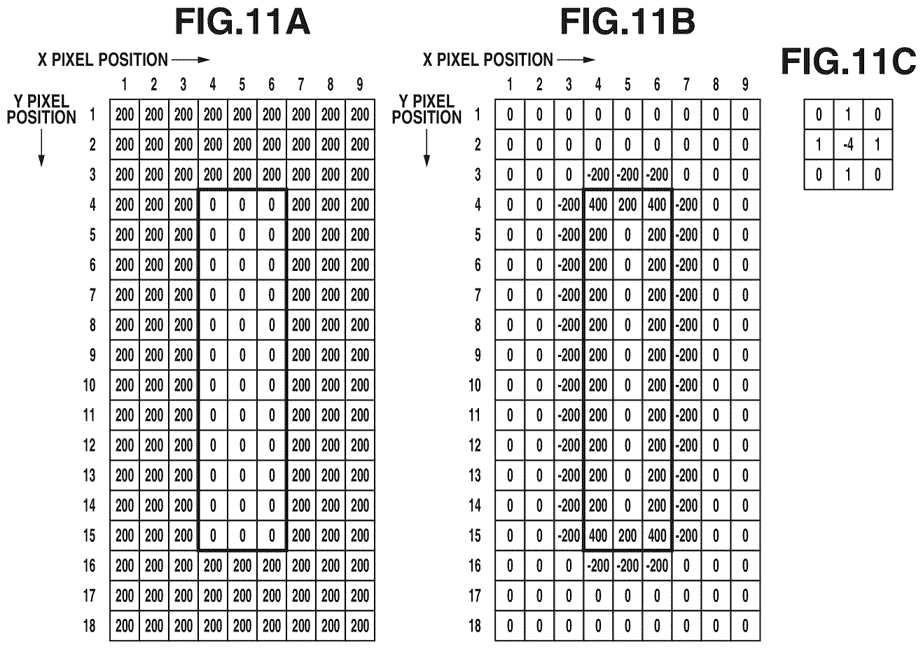

FIGS. 11A to 11C are diagrams for describing the edge detection processing in the case of using the ink containing the foaming inhibition component as the foaming control ink. FIG. 11A illustrates α′ data, where the region surrounded by the thick black frame is a foaming region. Since the F ink according to the present exemplary embodiment contains the foaming inhibition component, the amount of F ink to be applied to the foaming region is made relatively small, and the amount of F ink to be applied to the non-foaming region is made relatively large. In the α′ data generated based on α data, the gradation values of the pixels in the foaming region are therefore converted into relatively small values, or 0 in the present exemplary embodiment. On the other hand, the gradation values of the pixels outside the foaming region are converted into relatively large values, or 200 in the present exemplary embodiment. The conversion into the α′ data is performed by the foaming data height setting unit 601 of FIG. 6 in step S1004 of FIG. 10. FIG. 11B is a diagram illustrating the result of the edge detection processing on the α′ data. FIG. 11C is a diagram illustrating the Laplacian filter used for the edge detection. The edge detection processing is similar to that described with reference to FIGS. 7A to 7C.

The Laplacian filter of FIG. 11C is applied to the α′ data of FIG. 11A, whereby the edge detection result of FIG. 11B is derived. The inner edge pixels have positive values, and the outer edge pixels have negative values. In other words, a pixel is determined to be an inner edge pixel if the sign is positive, and an outer edge pixel if the sign is negative. The relationship between the positive and negative signs and the inner and outer edge pixels in FIG. 11B is reverse to that between the positive and negative signs and the inner and outer edge pixels in FIG. 7B. In the first exemplary embodiment, inner edge pixels are detected as edge pixels. In the present exemplary embodiment, outer edge pixels are detected as edge pixels since the foaming inhibition liquid is used. The foregoing edge detection processing on the α′ data is performed by the foaming data edge detection unit 602 in step S1005 of FIG. 10.

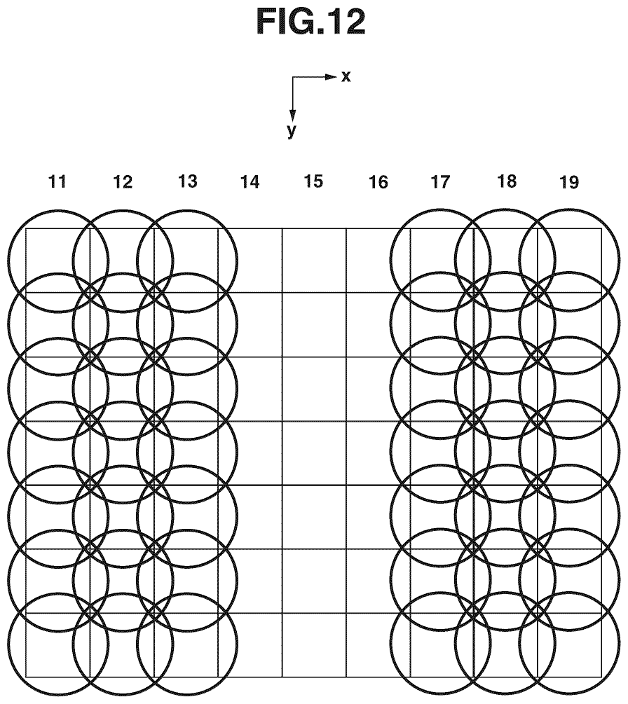

FIG. 12 is a diagram illustrating the overlapping of ink dots of the foaming inhibition liquid. The pixels in columns 14, 15, and 16 arranged in the X direction constitute a foaming region. The pixels in the other columns constitute non-foaming regions. Although not illustrated in the diagram, the non-foaming regions further extend in the −X direction from column 11 and in the +X direction from column 19.

Since the foaming inhibition component is used, the F ink that is the foaming inhibition liquid is applied more to the pixels in the non-foaming regions. FIG. 12 illustrates an example where dots are formed only in the non-foaming regions.

The pixels in column 13 overlap only the dots on the pixels in column 12. The pixels in column 17 overlap only the dots on the pixels in columns 18. The pixels in the columns of the non-foaming regions other than columns 13 and 17 overlap the dots on the pixels in two adjoining columns. The foaming-inhibiting function acting on columns 13 and 17 thus decreases than that on the other columns of the non-foaming regions, and the foaming height can thus be high. This reduces a difference in the foaming height from column 15, and decreases the visibility of the foaming region.

In the present exemplary embodiment, the amount of application of the foaming inhibition liquid to the pixels in columns 13 and 17 is thus controlled to be greater. The amount of application of the foaming inhibition liquid in columns 13 and 17 is increased to compensate for the small amount of ink overlap in columns 13 and 17 compared to the ink dot overlap in columns 12 and 18. The increment in the gradation value with respect to the amount of the foaming inhibition liquid to be added can be calculated using FIG. 5B. The calculated increment in the gradation value is added to the gradation values of the pixels in columns 13 and 17 of the α′ data, whereby α″ data is generated. The pixels to increase the gradation values of in columns 13 and 17 are detected as outer edge pixels by the foaming data edge detection unit 602. The foregoing conversion into the α″ data is performed by the foaming data pixel value adjustment unit 603 in step S1006 of FIG. 10. Like the first exemplary embodiment, the α″ data is 12-bit data.

Return to FIG. 10, in step S1010, the quantization processing is performed on the α″ data, whereby quantization data is generated. The quantization result is such that the amount of application of the foaming inhibition liquid to the outer edge pixels increases compared to the case where the α data is quantized. In step S1012, the heating unit 107 heats the recording medium 112 to which the inks are applied. Since the amount of application of the foaming inhibition liquid to the outer edge pixels increases compared to the case where the gradation values of the outer edge pixels are not adjusted, the foaming of the outer edge pixels is inhibited. In step S1013, the processing ends. The other steps of FIG. 10 not mentioned in the present exemplary embodiment are similar to the those of the first exemplary embodiment. A description thereof will thus be omitted.

In the case of using the foaming inhibition component, the configuration described above can prevent a decrease in the foaming height of the edges of foaming regions at the outer pixels of the foaming regions.

In the first exemplary embodiment, to add the foaming promotion liquid for the inner edge pixels of a foaming region, the gradation values of the inner edge pixels are controlled to increase. In the second exemplary embodiment, to add the foaming inhibition liquid for the outer edge pixels of a foaming region, the gradation values of the outer edge pixels are controlled to increase. In a third exemplary embodiment, to thin out the foaming control ink for the pixels inside a foaming region except for the inner edge pixels or the pixels outside a foaming region except for the outer edge pixels, the gradation values of the pixels inside the foaming region except for the inner edge pixels or the pixels outside the foaming region except for the outer edge pixels are reduced.

If, in FIG. 7A, the maximum value of 255 is set for the pixels in the foaming region inside the thick black frame in the α′ data, the gradation values of the inner edge pixels are unable to be increased. In such a case, the gradation values of the pixels inside the foaming region except for the inner edge pixels are reduced. The gradation values are reduced to thin out the amount of the foaming promotion liquid corresponding to the area S. For example, in the present exemplary embodiment, the horizontal axis of FIG. 5B is rephrased with the amount of ink to be thinned out, and the vertical axis of FIG. 5B is rephrased with the decrement in the gradation value. The decrement in the gradation value can thus be calculated from the amount of the foaming promotion liquid corresponding to the area S to be thinned out. The calculated decrement in the gradation value is subtracted from the gradation values of the pixels inside the foaming region except for the inner edge pixels, whereby the α′ data is converted into α″ data. This enables the formation of a three-dimensional image having inner edges of which a relative decrease in foaming promotion inside the foaming region is suppressed, whereby a degradation in the visibility of the foaming region can be prevented. In the present exemplary embodiment, the maximum value of 255 is described to be set for the pixels in the foaming region inside the thick black frame in the α′ data. However, this is not restrictive. Even when gradation values smaller than the maximum value are set, a three-dimensional image having inner edges of which a relative decrease in foaming promotion inside the foaming region is suppressed can be formed by performing the foregoing thinning.

If, FIG. 11A, the maximum value 255 is set for the pixels other than those of the foaming region inside the thick black frame in the α′ data, the gradation values of the outer edge pixels are unable to be increased. In such a case, the gradation values of the pixels outside the foaming region except for the outer edge pixels are reduced. The gradation values are reduced to thin out the amount of the foaming inhibition liquid corresponding to the area S. For example, in the present exemplary embodiment, the horizontal axis of FIG. 5B is rephrased with the amount of ink to be thinned out, and the vertical axis of FIG. 5B is rephrased with the decrement in the gradation value. The decrement in the gradation value can thus be calculated from the amount of the foaming inhibition liquid corresponding to the area S to be thinned out. The calculated decrement in the gradation value is subtracted from the gradation values of the pixels outside the foaming region except for the outer edge pixels, whereby the α′ data is converted into α″ data.

This enables the formation of a three-dimensional image having outer edges of which a relative decrease in foaming inhibition outside the foaming region is suppressed, whereby a degradation in the visibility of the foaming region can be prevented. In the present exemplary embodiment, the maximum value of 255 is described to be set for the pixels other than those of the foaming region inside the thick black frame in the α′ data. However, this is not restrictive. Even when gradation values smaller than the maximum value are set, a three-dimensional image having outer edges of which a relative degradation in foaming inhibition outside the foaming region is suppressed can be formed by performing the foregoing thin-out processing.

### Other Exemplary Embodiments

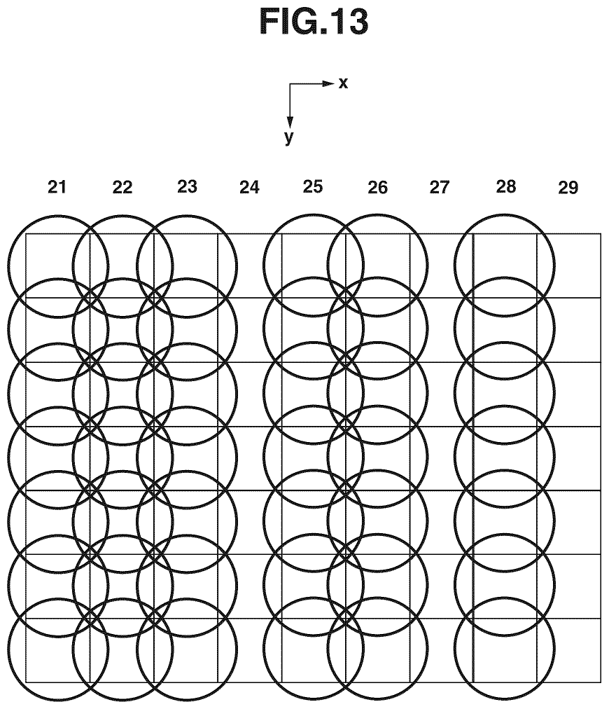

FIG. 13 is a diagram for describing overlapping of ink dots in foaming regions with different numbers of pixels in the X direction (different X widths or different transverse pixel widths). Columns 21 to 23 in this diagram constitute a foaming region with a pixel width of 3 in the X direction. Columns 25 and 26 in this diagram constitute a foaming region with an X width of 2. When the Laplacian filter of FIG. 7C is applied, columns 25 and 26 are detected as inner edge pixels. The increment in the gradation value applied to columns 21 and 23 that are inner edge pixels for a pixel width of 3 in the X direction is added to the gradation values in columns 25 and 26 that are inner edge pixels for a pixel width of 2 in the X direction. The foaming region with a pixel width of 2 in the X direction can thus form an edge shape equivalent to that of the foaming region with a pixel width of 3.

Column 28 in FIG. 13 constitutes a foaming region with a pixel width of 1 in the X direction. When the Laplacian filter of FIG. 7C is applied, column 28 is detected as inner edge pixels. The increment in the gradation value applied to columns 21 and 23 that are inner edge pixels for a pixel width of 3 in the X direction is added to the gradation values of column 28 that is inner edge pixels for a pixel width of 1 in the X direction. The foaming region with a pixel width of 1 in the X direction can thus form an edge shape equivalent to that of the foaming region with a pixel width of 3. If the Laplacian filter of FIG. 7C is applied to a not-illustrated foaming region with a pixel width of 4 or more in the X direction, both end columns in the foaming region are detected as inner edge pixels. The increment in the gradation value applied to columns 21 and 23 that are inner edge pixels for a pixel width of 3 in the X direction is added to the gradation values of both end columns that are inner edge pixels for a pixel width of 4 or more in the X direction. The foaming region with a pixel width of 4 or more in the X direction can thus form an edge shape equivalent to that of the foaming region with a pixel width of 3 in the X direction.

The Laplacian filters of FIGS. 7C and 11C can detect edges in the X direction and edges in the Y direction. Using the methods described in the first and second exemplary embodiments, the gradation values of edge pixels in the X and Y directions can thus be adjusted and converted into α″ data.

In the foregoing exemplary embodiments, the foaming data is described to be processed by the PC 200, and the image processing of the color image is described to be performed by the recording apparatus 100. However, this is not restrictive. The recording apparatus 100 may process the foaming data, and the PC 200 may perform the image processing of the color image.

It is sufficient if the data quantized in step S1010 of FIG. 10 is present in the recording apparatus 100.

The configuration of the first exemplary embodiment can be employed if there is a difference between the overlapping amount of ink dots at the inner edge pixels inside a foaming region and the overlapping amount of ink dots at the other pixels inside the foaming region as illustrated in FIG. 8B. If there is no difference, the gradation values of the inner edge pixels do not need to be adjusted. A gradation value threshold across which the difference becomes noticeable or not is determined by experiment in advance. The foaming data pixel value adjustment unit 603 compares the gradation values in the α′ data with the threshold. If the gradation values in the α′ data are greater than or equal to the threshold, the gradation values of the inner edge pixels are adjusted as described in the first exemplary embodiment. The configuration of the second exemplary embodiment can be employed if there is a difference between the overlapping amount of ink dots at the outer edge pixels outside a foaming region and the overlapping amount of ink dots at the other pixels outside the foaming region as illustrated in FIG. 12. If there is no difference, the gradation values of the outer edge pixels do not need to be adjusted.

A gradation value threshold across which the difference becomes noticeable or not is determined by experiment in advance. If the gradation values in the α′ data are greater than or equal to the threshold, the gradation values of the outer edge pixels are adjusted as described in the second exemplary embodiment.

In the first exemplary embodiment, the foamable particles are described to be thermally foamed. However, the foaming method is not limited to heating as long as the configuration can foam the foamable particles. Examples may include electromagnetic irradiation, aside from the application of thermal energy.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-189478, filed Nov. 6, 2023, which is hereby incorporated by reference herein in its entirety.

What is claimed is:

1. An image processing apparatus comprising:
an application unit configured to apply a foaming promotion component to a recording medium including a foaming layer containing foamable particles to foam, the foaming promotion component being configured to promote foamability of the foamable particles;
a foaming unit configured to foam the foamable particles by applying energy to the recording medium to which the foaming promotion component is applied by the application unit;
an acquisition unit configured to acquire foaming data where a gradation value for applying the foaming promotion component is set for each pixel;
a detection unit configured to detect an inner edge pixel based on the foaming data, the inner edge pixel being located inside a border of a foaming region where the foamable particles are foamed with a non-foaming region where the foamable particles are not foamed; and
a generation unit configured to generate the gradation value so that an amount of application of the foaming promotion component to the inner edge pixel detected by the detection unit increases compared to an amount of application of the foaming promotion component indicated by the foaming data acquired by the acquisition unit.

2. The image processing apparatus according to claim 1, wherein the foaming unit is a heating unit configured to foam the foamable particles by heating.

3. The image processing apparatus according to claim 1, further comprising a unit configured to accept a value indicating a foaming height,
wherein the generation unit is configured to generate the gradation value based on the value indicating the foaming height.

4. The image processing apparatus according to claim 1, wherein the detection unit is configured to detect one pixel inside the border as the inner edge pixel.

5. The image processing apparatus according to claim 1, wherein the generation unit is configured to, in a case where the foaming data acquired by the acquisition unit reaches or exceeds a predetermined threshold, generate the gradation value so that the amount of application of the foaming promotion component to the inner edge pixel increases compared to the amount of application of the foaming promotion component indicated by the foaming data.

6. An image processing method for an image processing apparatus including an application unit configured to apply a foaming promotion component to a recording medium including a foaming layer containing foamable particles to foam, the foaming promotion component being configured to promote foamability of the foamable particles, and a foaming unit configured to foam the foamable particles by applying energy to the recording medium to which the foaming promotion component is applied by the application unit, the image processing method comprising:
acquiring foaming data where a gradation value for applying the foaming promotion component is set for each pixel;
detecting an inner edge pixel based on the foaming data, the inner edge pixel being located inside a border of a foaming region where the foamable particles are foamed with a non-foaming region where the foamable particles are not foamed; and
generating the gradation value so that an amount of application of the foaming promotion component to the detected inner edge pixel increases compared to an amount of application of the foaming promotion component indicated by the acquired foaming data.

7. A storage medium storing a program for causing a computer to perform the image processing method according to claim 6.

8. An image processing apparatus comprising:
an application unit configured to apply a foaming inhibition component to a recording medium including a foaming layer containing foamable particles to foam, the foaming inhibition component being configured to inhibit foamability of the foamable particles;
a foaming unit configured to foam the foamable particles by applying energy to the recording medium to which the foaming inhibition component is applied by the application unit;
an acquisition unit configured to acquire foaming data where a gradation value for applying the foaming inhibition component is set for each pixel;
a detection unit configured to detect an outer edge pixel based on the foaming data, the outer edge pixel being located outside a border of a foaming region where the foamable particles are foamed with a non-foaming region where the foamable particles are not foamed; and
a generation unit configured to generate the gradation value so that an amount of application of the foaming inhibition component to the outer edge pixel detected by the detection unit increases.

9. An image processing method for an image processing apparatus including an application unit configured to apply a foaming inhibition component to a recording medium including a foaming layer containing foamable particles to foam, the foaming inhibition component being configured to inhibit foamability of the foamable particles, and a foaming unit configured to foam the foamable particles by applying energy to the recording medium to which the foaming inhibition component is applied by the application unit, the image processing method comprising:
acquiring foaming data where a gradation value for applying the foaming inhibition component is set for each pixel;
detecting an outer edge pixel based on the foaming data, the outer edge pixel being located outside a border of a foaming region where the foamable particles are foamed with a non-foaming region where the foamable particles are not foamed; and
generating the gradation value so that an amount of application of the foaming inhibition component to the detected outer edge pixel increases.
